(19) United States
(12) Patent Application Publication
(10) Pub. No.: US 2019/0323728 A1
(43) Pub. Date: Oct. 24, 2019

(54) IN-LINE HIGH PURITY CHEMICAL HEATER

(71) Applicants: Howard J. Base, Macedonia, OH (US); Derrick L. Sanislo, Thompson, OH (US)

(72) Inventors: Howard J. Base, Macedonia, OH (US); Derrick L. Sanislo, Thompson, OH (US)

(73) Assignee: Tom Richards, Inc., Mentor, OH (US)

(21) Appl. No.: 16/383,235

(22) Filed: Apr. 12, 2019

Related U.S. Application Data
(60) Provisional application No. 62/660,674, filed on Apr. 20, 2018.

(51) Int. Cl. F24H 1/14; F28F 1/40; H05B 3/58

(52) U.S. Cl. CPC F24H 1/142; F28F 1/12; H05B 3/58; F28F 1/40

(57) ABSTRACT

A heater assembly includes a heated hose construction including a thermoplastic conduit that is relatively thin and a resistance wire or resistance ribbon wound around an exterior periphery of the conduit and in thermal communication therewith. An overall coverage of a surface area of the conduit by the resistance wire or resistance ribbon is at least 50% of the surface area of the conduit so that the resistance wire or resistance ribbon reinforces the conduit. A non-conductive braid layer is disposed over the resistance wire or resistance ribbon. The braid layer is permeable to vapor leaking out of the conduit. A support member is provided by which the heated hose construction is supported. The support member may be accommodated in a housing through which a purge gas flows.

### BACKGROUND

This application claims the benefit of Provisional Application Ser. No. 62/660,674 which was filed on Apr. 20, 2018. The entire content of that application is incorporated hereinto by reference.

The present disclosure relates to chemical heaters. More particularly, it pertains to a new and improved in-line chemical heater which provides a more cost effective solution to heating ultrapure chemicals than what is currently available on the market.

In a traditional in-line chemical heater, the heating element is formed in a compact shape, such as a helix or a U, and is inserted into a sealed pressure vessel. The fluid to be heated then flows within the chamber enclosing the formed heating element. As such, the fluid creates eddies in certain areas around the heating element. Such eddies, are, of course, disadvantageous. In addition, conventional in-line chemical heaters have stagnant areas within the fluid flow path and these areas are known to be disadvantageous. Other conventional heater designs have a fluid flow path which has excessively turbulent areas and such areas are also disadvantageous.

Many industries require the use of heat exchangers to regulate the temperature of high purity and/or corrosive fluids. For example, microchip fabrication processes in the semiconductor industry require the heating and temperature regulation of etching and/or cleaning fluids that are used to etch and/or clean silicon wafers and microcircuit lines. Because both the process temperatures and the heat capacities of the etching/cleaning fluids are relatively high, a rather large amount of heat is required to raise and maintain the temperature of the etching/cleaning fluid at the desired level. Moreover, since these fluids are corrosive by nature, a chemically inert material, such as polytetrafluoroethylene (PTFE, sold by DuPont under the trademark Teflon®) or another suitable polymer needs to be used to either carry the fluid or to protect the resistive heating element from being corroded. Although chemically inert, PTFE and other such polymers are disadvantageous because they are very poor heat conductors. Therefore, the thermal transfer between the heat source and the fluid meant to be heated is limited by the need to employ such chemically inert materials.

Conduits convey liquids and gases between spaced locations. The term “conduit” refers to any generally tubular elongated member and includes flexible devices which are commonly referred to as hoses, tubes, pipes and the like. Such conduits may be made from thermoplastic materials and may be of a single wall or a multiple wall construction and may be reinforced or not reinforced. In this disclosure, the term “conduit” encompasses all of these members or devices.

From a cost perspective, the most expensive portion of such a heating assembly is the fluoropolymer or similar chemically inert thermoplastic tubing material. Thus, it would be advantageous to reduce the thickness of the thermoplastic tubing in order to reduce the cost of the heating unit as a whole. However, if the wall of the tube is made too thin, then it needs to be supported or reinforced so that it does not rupture leading to a spill of the fluid that flows through the tube and which is being heated, particularly if the fluid is corrosive and might adversely affect other components of the system. It would be advantageous to coil a resistance heating wire or ribbon around a relatively thin thermoplastic tube, which constitutes a fluid flow path, in order to reinforce the tube. With such a construction, the resistance wire or ribbon would not only provide the heat source for the fluid flowing through the tubing but would also reinforce the tubing. At the same time, it would be advantageous to provide an electrical insulator between successive coils of the resistance wire or ribbon.

It would also be desirable to provide a heating assembly which employs a straight through flow path such that the fluid which is to be heated flows continuously through the tube without any stagnant sections or excessively turbulent sections being located in the tube. A straight through flow path would minimize the length of the heating assembly and reduce the hold up time it takes to heat the process fluid to the desired temperature. In addition, it would be desirable to provide the heating assembly with a ground plane which is designed to be connected to earth ground when the heater is energized. In this way, if a leak should ever develop, a current path to ground would be provided allowing the heater to be then shut down.

### BRIEF SUMMARY

According to one embodiment of the present disclosure, a heater assembly comprises a heated hose construction comprising a thermoplastic conduit having a wall thickness between 0.003 and 0.045 inches (0.0076 and 0.1143 cm) through which conduit a process fluid to be heated flows. A resistance wire or ribbon is wound around an exterior periphery of the conduit and is in thermal communication therewith. An overall coverage of a surface area of the conduit by the resistance wire or ribbon is at least 50% of the surface area of the conduit so that the resistance wire or ribbon reinforces or supports the conduit. A non-conductive braid layer is disposed over the resistance wire or ribbon, wherein the braid layer is permeable to vapor leaking out of the conduit. A support member is provided by which the heated hose construction is supported.

In accordance with another embodiment of the present disclosure, a method is provided for manufacturing a heater assembly. The method comprises providing a thermoplastic conduit having a wall thickness between 0.003 and 0.045 inches (0.0076 and 0.1143 cm). A resistance wire or ribbon is positioned around the conduit. The conduit is reinforced with the resistance wire or ribbon such that an overall coverage of an exterior surface area of the conduit by the resistance wire or ribbon is at least 50% of the exterior surface area of the conduit. A non-conductive braid layer is positioned over the resistance wire or ribbon to define a heated hose construction. The heated hose construction is mounted on a support member.

One advantage of such a heater assembly is that the thermoplastic conduit has a relatively thin wall and, as such, the poor heat transfer properties of the thermoplastic material of the conduit is mitigated. At the same time, the thermoplastic conduit is suitably reinforced by the resistance wire or ribbon so that it does not have a tendency to rupture. Also, the cost of such a heater assembly is reduced because the amount of thermoplastic used in the conduit is reduced. Moreover, a braid layer can be disposed over the resistance wire or ribbon, with the braid layer being permeable to a vapor leaking out of the conduit. The braid layer is non-conductive so as to electrically insulate the resistance wire or ribbon. In addition, a straight line ultrapure flow path is provided by the reinforced thermoplastic conduit which allows for an overall length of the heat transfer assembly to be as short as possible thereby minimizing a contact area between the fluid to be heated and the thermoplastic conduit, thus also improving a purity of the fluid to be heated and minimizing hold up time.

### BRIEF DESCRIPTION OF THE DRAWINGS

The disclosure may take physical form in certain parts and arrangements of parts, several embodiments of which will be described in detail in this specification and illustrated in the accompanying drawings which form a part hereof and wherein:

FIG. 1 is a cross sectional view through a heater construction according to one embodiment of the present disclosure;

FIG. 2 is a reduced size cross sectional view through a heater assembly employing the heater construction of FIG. 1;

FIG. 3 is a cross sectional view through a portion of a heater construction according to another embodiment of the present disclosure;

FIG. 4 is a cross sectional view through still another embodiment of a portion of a heater construction according to the present disclosure;

FIG. 5 is a cross sectional view through a heater assembly according to a further embodiment of the present disclosure;

FIG. 6 is a side elevational view of the heater assembly of FIG. 5;

FIG. 7 is a perspective view of the heater assembly of FIG. 6;

FIG. 8 is a cross sectional view through a yet further embodiment of a heater assembly according to the present disclosure;

FIG. 9 is a reduced side elevational view of the heater assembly of FIG. 8 illustrated with additional components;

FIG. 10 is a chart regarding a number of characteristics of heater constructions according to the present disclosure; and

FIG. 11 is a cross sectional view of a heater assembly according to a still further embodiment of the present disclosure.

### DETAILED DESCRIPTION

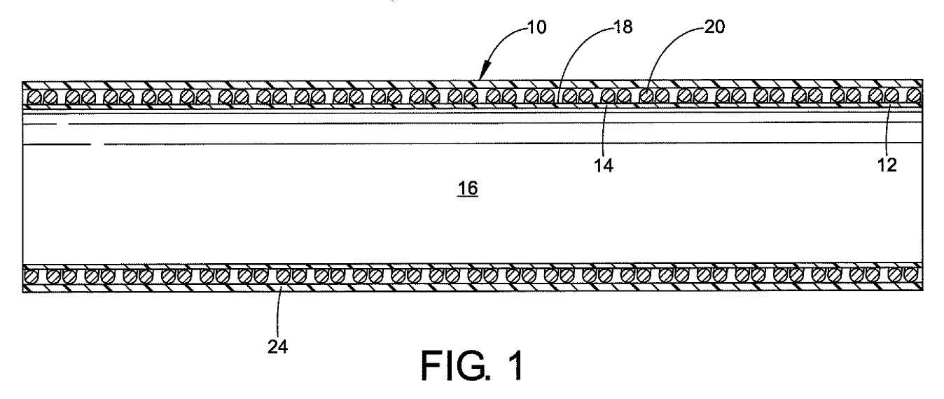

Referring now to the drawings wherein the showings are for purposes of illustrating several embodiments of the present disclosure only and not for purposes of limiting same, FIG. 1 shows one embodiment of a heater assembly according to the present disclosure. In this embodiment, a heater assembly 10 includes a tubular conduit such as a tube or hose 12 which is made of a suitable chemically inert thermoplastic material such as polytetrafluoroethylene (PTFE, sold by DuPont of Delaware under the trademark Teflon®), perfluoroalkoxy resin (PFA) or a fluorinated ethylene propylene (FEP) material. These fluoropolymers are heat stable and are also relatively flexible. However, conduits containing fluoropolymers typically do not possess high strength. This is of concern if the conduit is of extended length and is required to support its own weight. Moreover, the strength of a fluoropolymer conduit may be adversely affected by the elevated temperatures to which the conduit may be heated. Further, such fluoropolymer materials are poor heat conductors. Also, fluoropolymer tubes exhibit a measure of permeation to certain gases, particularly acid gases.

In one embodiment, the thickness of the conduit can be between 0.003 and 0.045 inches (0.0076 and 0.1143 cm). For example, a wall thickness of the tube or hose 12 can be between 0.010 to 0.030 inches (0.025 to 0.076 cm) or more preferably between 0.018 and 0.020 inches (0.046 and 0.051 cm). It should be appreciated that providing a relatively thin wall for the conduit 12 enhances heat transfer through the conduit, making for a more efficient heater assembly. As might be appreciated, the process fluid which is meant to be heated flows through the conduit 12. The tube or hose, which can be extruded if so desired, includes an interior wall 14 which defines a fluid flow path 16 and an exterior wall 18. Wound around the exterior wall 18 is a flexible heating element such as a resistance wire or ribbon 20 which is in a heat transfer relationship with the conduit 12. The resistance wire or ribbon 20 engages and supports or reinforces the conduit 12.

Thermoplastic materials, particularly fluoropolymers, are not very efficient for use in heat transfer applications. In fact, they are better suited as insulator materials, rather than as heat transfer materials. However, their resistance to corrosive chemicals is highly desirable, as is their cleanliness. As a result, a relatively large amount of surface area of the thermoplastic tube or hose must be employed to transfer enough heat to be useful. Because such a thermoplastic material transfers heat so poorly, the resistance coil needs to cover a significant percentage of the surface area of the tube or hose because it is only those areas of the conduit which are directly located beneath the resistance wire which transfer heat to the process fluid flowing through the tube or hose.

Due to the relatively thin wall of the tube or hose 12, it needs to be reinforced by the resistance wire or ribbon in order to prevent a rupture of the tube and a consequent release of the fluid which is being heated in the heated hose construction. In one embodiment, an overall coverage of the external surface area of the tube or hose by the resistance wire or ribbon is greater than 50% of the exterior wall surface of the tube so that the resistance wire or ribbon serves to also reinforce the tube. It should be recognized that the overall coverage of the outer wall of the tube or hose by the resistance wire or ribbon could change based upon the tube thickness and the temperature and pressure rating for the finished heated hose construction.

Most heated hose constructions use a single helix of resistance wire of an appropriate gauge and suitable alloy to achieve the desired heating power at a given applied voltage. A typical design goal of most heater assemblies is to use as little resistance wire as possible. In contrast, in the present disclosure, much more resistance wire is used than is typical. In fact, nearly five times as much resistance wire is used as a function of weight when compared to typical heated hose designs. To some extent, this is due to the poor heat transfer capacity of the thermoplastic material employed in the disclosed tubular conduit. But, the use of so much resistance wire or ribbon is also necessary in order to support the relatively thin walled tube or hose.

Sometimes, a double helix of resistance wire is used in heater designs. The number of helices of resistance wire or ribbon used can be more or less depending upon the power and voltage required. In one embodiment of the present disclosure, a triple helix design of a relatively small gauge resistance wire is employed (see FIG. 4). Such a triple helix resistance wire or ribbon design is much more than what is available in a typical heater element. One benefit of increasing the number of wires and decreasing the space between the wires is that such a design will decrease the thermal gradient along the tube or hose, thereby improving the performance of the heater assembly. As an example, a triple helix of 20 gauge (0.32 inch diameter, 0.81 cm) resistance wire would provide a helix of between 5 and 7 turns per inch (2.54 cm) of conduit length.

As mentioned, a ribbon type wire is also contemplated because a ribbon would provide more support and coverage of the relatively thin thermoplastic tubing. However, such a ribbon may be more difficult to wind around the tube or hose. It is contemplated that between 50% and 70% coverage of the outer surface of the conduit with the resistance wire or ribbon would be advantageous. It is contemplated that 50% would be the minimum coverage area of the wire or ribbon over the surface area of the conduit. However, the coverage area could be up to 100%. To achieve 100% coverage would require that the resistance coil be oxidized prior to assembly to prevent shorting between its successive turns. In one embodiment, a watt density of the resistance wire or ribbon can be between 2 watts per square inch (0.31 w/cm²) and 50 watts per square inch (7.75 w/cm²). For example, the watt density could be between 5 to 20 watts per square inch (0.78 to 3.10 w/cm²).

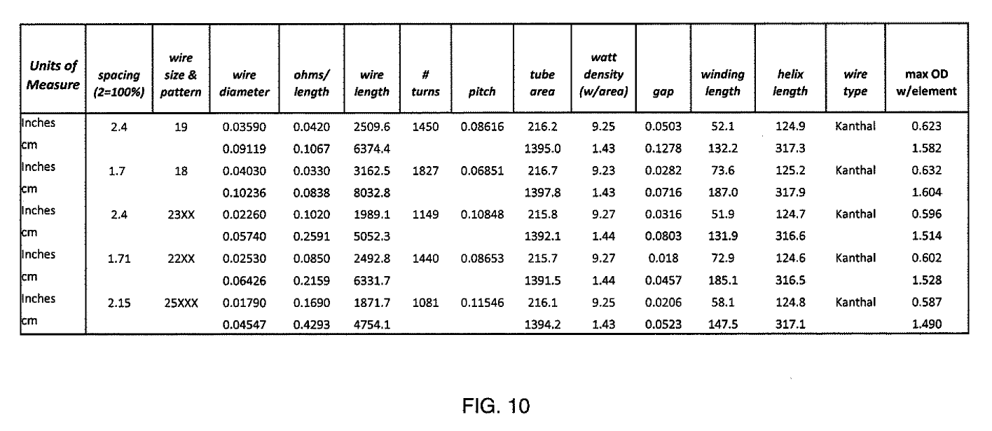

FIG. 10 shows a table with a variety of types of wiring layouts in a variety of wire sizes. In the table in which measurements are listed in both the American measurement system as well as the metric system, the wattage, voltage, amperage, resistance and tubing outer diameter are the same for each of the examples. More specifically, the wattage is 2000 watts, the voltage is at 460 volts, the amperage is at 4.35 amps, and the resistance is at 105.80 ohms. The tubing outer diameter is in each case 0.551 inches (1.4 cm). What is different in each case is the spacing of the wire or ribbon, the wire size in American wire gauge and pattern (with XX indicating two wires and XXX indicating three wires), the wire diameter in in./cm, the ohms per in./cm, the number of turns of the wire, the pitch, the tube area in in²/cm², the watt density in watts/in² or watts/cm², the gap between coils in in./cm, winding length in in./cm and helix length in in./cm as well as the maximum outer diameter of the tube and wiring combination once the wiring is in place on the tube in in./cm.

It may be desirable to use a smaller diameter wire with multiple parallel helices in order to improve heat transfer and also to improve the support of the relatively thin-walled conduit. Put another way, the larger the diameter of the wire, the less support is provided by the wire for the wall of the tube or hose and the less effective heat transfer area is provided for the process fluid flowing through the tube or hose. In one embodiment, the wire can be wound on a metal mandrel and then sleeved onto the conduit. This may be advantageous so that the relatively thin-walled thermoplastic conduit does not have to support the wire during the process of winding the wire onto the conduit. In one embodiment, the wire can have a maximum gauge of 10 (0.102 inch diameter, 0.25 cm) and a minimum gauge of 34 (0.006 inch diameter, 0.015 cm). Typically, the wire is likely to be anywhere from a 19 (0.040 inches, 0.11 cm) to 24 (0.022 inches, 0.056 cm) gauge wire.

In one embodiment, the wire can be a nichrome type wire (NiCr) which can be 80 percent nickel and 20 percent chromium or can include other elements or substances. On such material is sold under the trademark NIKROTHAL® by the Sandvik Group of Sweden. Sandvik applies the trademark NIKROTHAL® to a family of nickel-chromium (NiCr) alloys available in wire or ribbon (flat wire) form. It is used in a wide variety of resistance heating wire applications. However, other desirable resistance wire materials may include a copper and nickel wire (CuNi) or an iron, chromium and aluminum wire (FeCrAl). Nichrome is advantageous from the perspective that it provides good chemical resistance and has a high relative resistance, as well as stability at high temperatures.

The resistance wire or ribbon can be prevented from melting the conduit 12 by adjusting a watt density of the overall design. Typically, the watt density can be between 9 to 17 watts per square inch (1.40 to 2.64 w/cm²) of tubing surface. This yields an acceptable temperature differential under normal operating conditions between the coil and the process fluid being heated in the conduit.

Certain software can be used to monitor the rate of temperature rise of the heating element, i.e., the heating coil. In a condition where the heating construction may be inadvertently turned on without process fluid being present in the conduit, the heating element temperature would rise abnormally fast and trip a safety before reaching the normal temperature limit of the heating element. In this way, stored energy in the heating element is retarded or prevented from melting the conduit if the heating element were simply to be shut off at its temperature limit.

In one embodiment, a temperature control system can be provided to control the flow of electrical power to the flexible heating element in order to control the degree of heating of the heating element and the resulting heating of the process fluid in the conduit 12. For example, the temperature control system can be integrally mounted on the heated hose construction if so desired.

A non-conductive braid layer 24 can be disposed over the resistance wire or ribbon in a contacting relationship. In one embodiment, the non-conductive braid layer can be a fiberglass braid. Other types of non-conductive materials for the braid layer are also contemplated. The thickness of the braid layer is somewhat dependent upon the voltage that the heater is designed for. It is contemplated that the thickness of the braid layer would be no less than 0.010 inches (0.025 cm) and no more than 0.060 inches (0.152 cm). In one embodiment, the braid layer could be about 0.015 inches (0.038 cm) thick. The braid layer is considered to be advantageous for a number of reasons. First, the braid layer provides mechanical support to the resistance wire or ribbon during assembly in order to prevent the coiled wire or ribbon from stretching as it is applied to the tube. In other words, the braid layer keeps the coiled resistance wire or ribbon secure during manufacture of the heater assembly. This ensures uniform spacing of the resistance wire for both heat distribution and support of the conduit. Secondly, the braid layer provides electrical insulation of the coils of the heated hose construction from subsequent turns of the coiled heated hose construction around a center support. Third, the braid layer allows for leak detection by acting as a wick to absorb any process fluid which may have leaked from a damaged thin walled conduit. In other words, the braid layer or element provides a means for creating a ground fault in the event of a leak of the process fluid through the conduit 12. Finally, the braid layer provides a path for permeate to be easily removed via a purge gas, as will be described below.

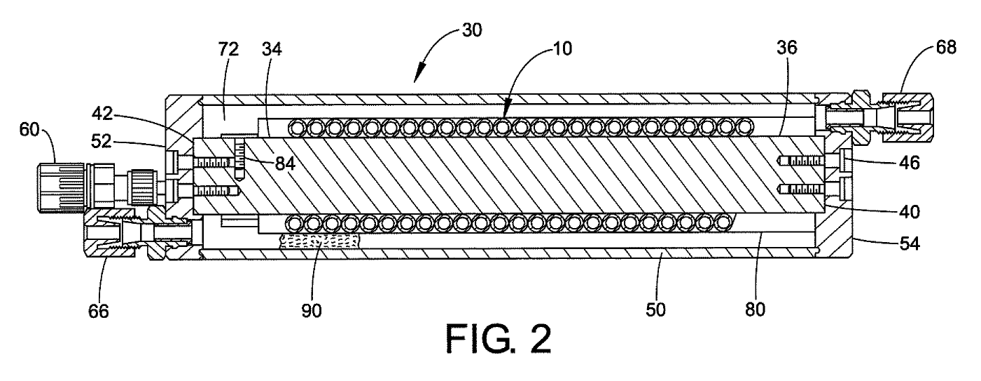

With reference now to FIG. 2, a heater assembly 30 includes a support member 34 around which the heated hose construction 10 can be wound. More particularly, the heated hose construction 10 is flexible enough that it can be wound around an exterior surface 36 of the support member 34. In this embodiment, the support member 34 can be a solid member, such as a cylinder, which includes a first end 40 and a second end 42. Fasteners 46 can extend into suitable bores defined in the first and second ends of the support member 34. It should be appreciated that the support member can be geometrically shaped other than as a cylinder, depending upon the space requirements of the heating installation in which the heater assembly is used. It is, however, desirable that the support member have radiused edges because the heated hose construction 10 needs to have a minimum bend radius. Thus, the support member 34 could have an oval or elliptical cross section, as well as a circular cross section. In other embodiments, the support member 34 can be hollow such that it includes an interior chamber. In one embodiment, the coiling of the heated hose construction 10 on the support member 34 can be such that the loops of the conduit contact each other or touch each other. In this case, the braid layer 24 can provide electrical insulation between the turns of the heated hose construction.

The support member 34 can be made of an inexpensive ceramic, such as cordierite or steatite. Alternatively, the support member can be a hollow metal structure which can also act as the ground plane. However, the ends of such a hollow member would need to be closed in order to direct a flow of the purge gas over the coiled heater construction. In one embodiment, a diameter of the support member 34 can be a minimum of 4 times the diameter of the conduit 12.

The support member can be enclosed in a housing or enclosure 50. In certain embodiments, the enclosure can be a sealed enclosure so as to prevent fluids, such as gases, from flowing in or out of the enclosure except at defined locations. The housing can include a first end cap 52, a second end cap 54 as well as an annular side wall 56 which is mounted to the pair of opposed end caps. In one embodiment, the housing can also be cylindrical. Of course, the housing can have other shapes, again depending upon the space requirements of the application. Mounted to the first end cap 52 can be a process fluid inlet or connection 60 which is fluidly connected to the thermoplastic tube or conduit 12 to allow process fluid to flow through the connection and subsequently through the thermoplastic tube. The process fluid then flows out of the other end of the tube via a connection which is not visible in this view.

The housing can be made of a suitable plastic material, such as the thermoplastic polypropylene. In other embodiments, the housing can be made of other thermoplastics or a coated steel material or a stainless steel material, if so desired. The cost of the housing would appear to be the most important factor in determining the material from which the housing is constructed because the main function of the housing is to enclose the heater assembly and to provide space for accommodating an insulation material in order to reduce heat loss, while at the same time allowing for purge gas to flow through the housing.

Mounted to the first end cap 52 is a purge fluid inlet connection 66 which is spaced from the process fluid inlet connection 60. Mounted to the second end cap 54 is a purge fluid outlet connection 68. An annular space or purge chamber 72 is defined within the housing 50. It is believed that the flow rate required to effectively remove any fluid which may permeate through the heater construction 10 can be quite small. In one embodiment, the flow rate can be somewhere between 0.5 to 5 standard cubic feet per hour (0.014 to 0.142 m³/hr) of purge gas. It is anticipated that a low flow rate, typically one to two standard cubic feet per hour (0.03 to 0.056 m³/hr) of an inert purge gas through the enclosure or housing 50, removes any process fluid which may have permeated through the thermoplastic heat exchange conduit or tubing. Further disclosure concerning the use of a purge gas in heater designs may be found in U.S. Pat. Nos. 4,553,024; 5,875,283 and 5,919,386, the disclosures of which are all incorporated hereinto by reference in their entireties. The gap between the outer surface of the coiled tubing and the inner wall of the housing or the space required for the insulation material can be quite small. The open area of the insulation would be sufficient for effective purge of any leakage out of the tubing. The housing or enclosure 50 thus provides a structural member to secure all the components, as well as providing an inert environment which allows both for leak detection and for prolonged heater life. It is believed that even at 100 percent coverage of the tube 12 by the resistance coil or ribbon 20, a purge would still be effective because the resistance coil would not seal the tube 12 against permeation or leakage.

In one embodiment, a ground plane or member 80 can enclose the heater construction 10. Additionally, the ground plane can be secured to the support member 34 via a suitable fastener 84. In other embodiments, the ground member could be located between the support member and the tube. It is contemplated that more than one ground plane can be provided in the assembly in order to minimize reaction time to any potential fault condition. For example, the ground member could be located between multiple tubes if so desired.

In one embodiment, a layer of insulation 90 can be provided between the ground plane 80 and an interior wall of the housing 50. The layer of insulation can be a ceramic material, such as fiberglass. Other types of thermal insulation, such as calcium silicate, ceramic fiber or alumina silicate are also contemplated. In fact, a rubber material such as a silicone foam could also be employed as the insulation material, if so desired.

In one embodiment, the heater assembly can have a flow rate between 1 and 10 liters per minute using a 0.5 inch (1.27 cm) diameter tube. In another embodiment, flow rates of 0.1 to 1.0 liters per minute can be provided in a tube having a diameter of 0.25 inches (0.635 cm).

It may be advantageous to provide temperature sensors on the resistance wire or ribbon 20 in order to allow a control to shut off power to the heater construction 10 in the event of an over temperature condition. It is clearly desirable to prevent the resistance wire or ribbon 20 from melting the tubing 12 by adjusting the watt density of the overall design of the heater wire or ribbon. As mentioned, the resistance wire or ribbon can be operated to achieve around 9 to 17 watts per square inch (59 to 109.7 w/cm²) of tubing surface.

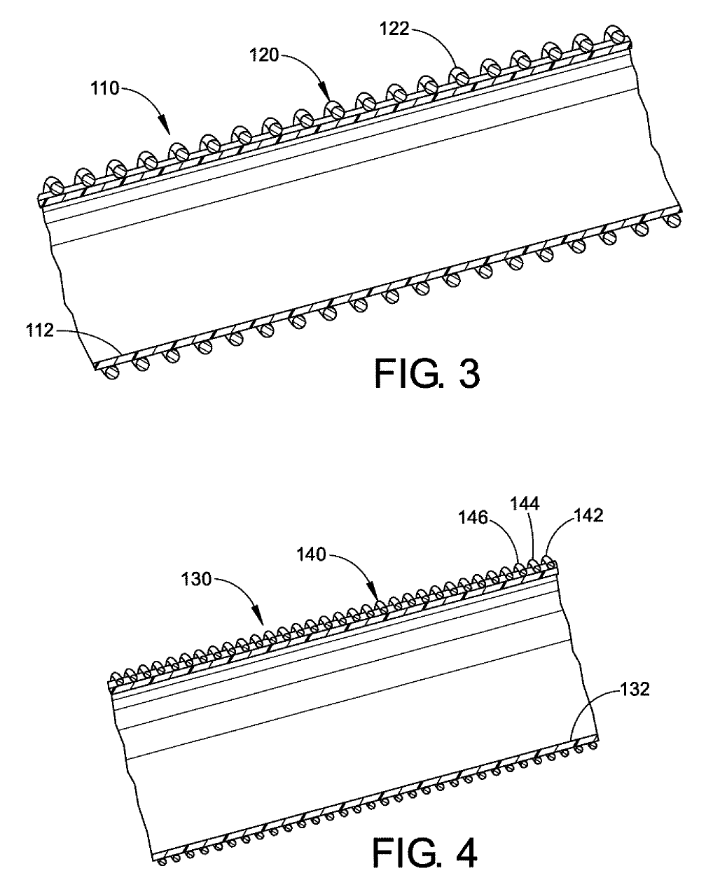

With reference now to FIGS. 3 and 4, these illustrate two equivalent resistance heater element designs. FIG. 3 shows a heater construction 110 comprising a conduit 112 around which is wound a resistance wire 120 that is coiled in a single helix as at 122. In contrast, FIG. 4 shows a heater construction 130 which comprises a conduit 132 around which is wound a resistance wire 140 in the form of a triple helix coil including first, second and third coils 142, 144 and 146. It should be appreciated that the resistance or heater wires 120 and 130 can have equal resistance for an equal length along the axis of the respective conduit. Thus, they will provide the same amount of heat to a process fluid which is flowing through the respective conduit 112, 132. However, the coil construction shown in FIG. 4 has more than two times the contact area with the conduit 132 as compared with the coil construction illustrated in FIG. 3. Thus, the resistance wire construction illustrated in FIG. 4 is better able to support the conduit 132 than is the resistance wire 120 illustrated in FIG. 3 able to support its conduit 112 and is better able to transfer heat to the process fluid flowing through conduit 132.

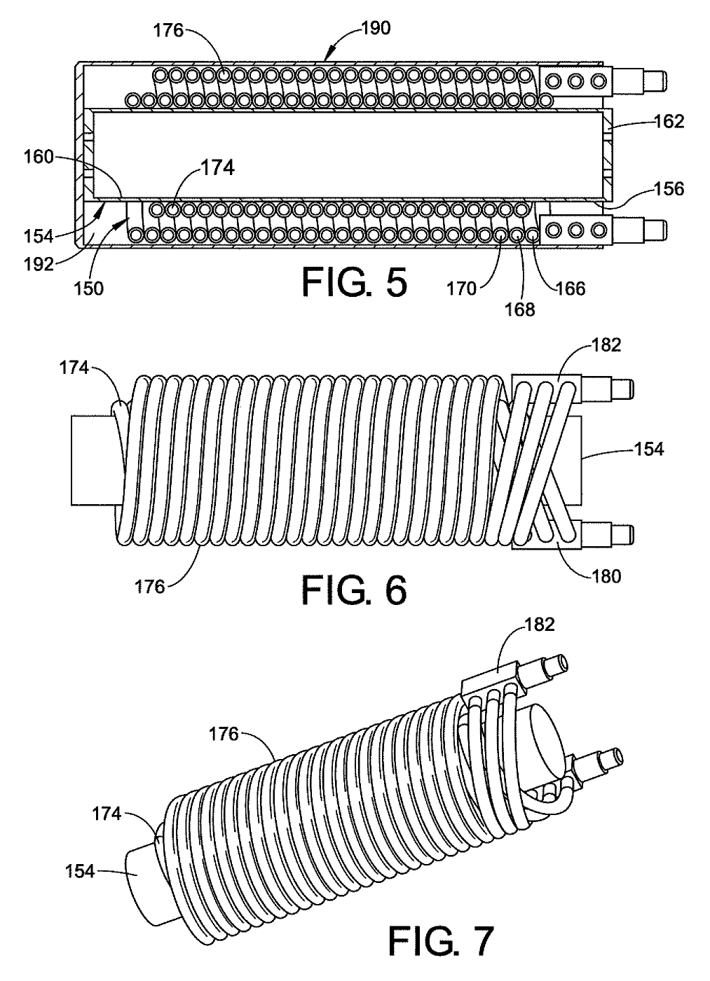

With reference now to FIG. 5, a heater assembly including heated hose construction 150 according to another embodiment of the present disclosure can include a support member 154 having an exterior wall 156, as well as an interior wall 158 which defines a chamber 160. In this embodiment, the support member can be made of a metal material and forms a ground 162. In addition, in this embodiment, the heated hose construction 150 can be coiled in a triple helix around the support member 154 and can then be coiled back over itself. More particularly, the heated hose construction 150 includes first, second and third coils 166, 168 and 170 that are formed into a first layer or interior coil layer 174 and also into a second layer or exterior coil layer 176. The two layers 174 and 176 can be separated from each other by a film or sheet of a known insulation material, is so desired. Also provided are an inlet manifold 180 and an outlet manifold 182 for the process fluid which is flowing through the heated hose construction 150. As shown in FIG. 5, a housing 190 encloses the support member 154 and the heated hose construction 150 which is wound around the support member. An annular space 192 is provided between the support member 154 and the housing 190 to accommodate the tubing layers 174 and 176 as well as to allow for purge fluid to flow through the housing 190.

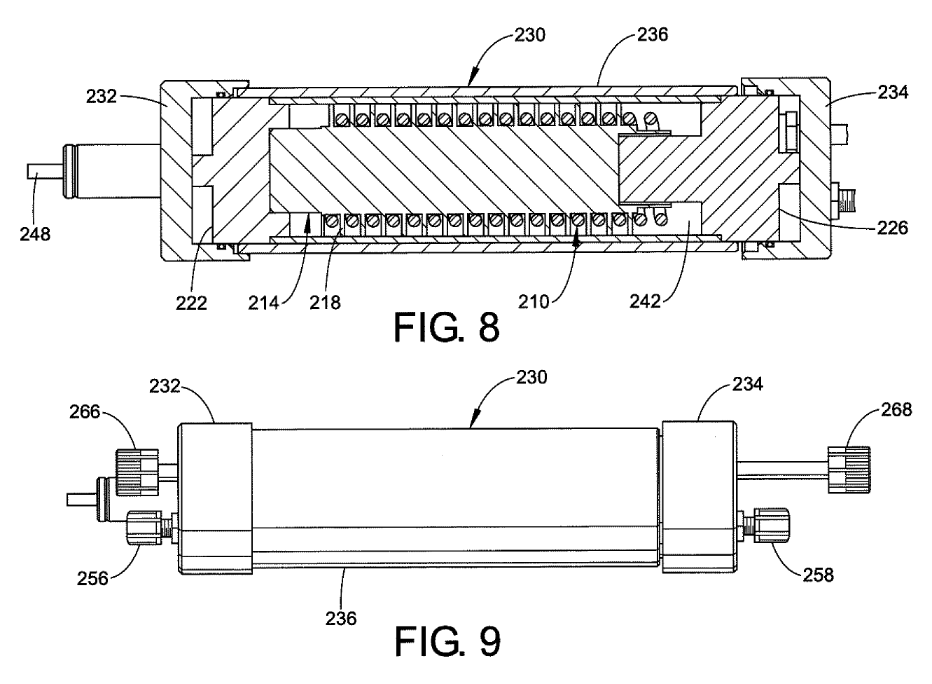

In yet a further embodiment of a heater assembly according to the present disclosure, as illustrated in FIGS. 8 and 9, a heated hose construction 210 is wound around a support member 214. In this embodiment, the support member can be a solid element which includes on its periphery a plurality of spaced ribs defining channels into which the heater construction 210 can be wound. A first end of the support member is mounted in a first base member 222 and a second end of the support member is mounted in a second base member 226. The two base members 222 and 226 and the support member 214 are held in a housing 230. The housing includes a first end cap 232 which is located adjacent the first base member 222 and a second end cap 234 which is located adjacent the second base member 226. Held between the two end caps 232 and 234 is an annular side wall 236 of the housing 230. Defined in the housing 230 is a purge chamber 242. Extending into the housing 230 are power leads 248 for the resistance wire or ribbon. With reference now also to FIG. 9, the first end cap 232 accommodates a purge fluid inlet connection 256 with the second end cap 234 accommodating a purge fluid outlet connection 258. Mounted to the first end cap 232 is a process fluid inlet connection 266. Mounted to the second end cap 234 is a process fluid outlet connection 268.

Disclosed has been a heated hose construction which is wound on a support member. The heated hose construction includes a conduit, i.e., any suitable thermoplastic hose or tube-like member, a heater device having an electrical resistance element in thermal communication with the tubular member and a braid layer disposed over the heater device. If desired, a thermal regulating device Which controls a flow of electrical current through the heater device based on a sensed temperature of the thermoplastic conduit can also be provided.

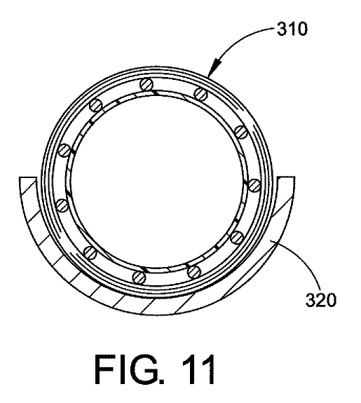

With reference now to FIG. 11, another embodiment of a heated hose construction is there disclosed. In this embodiment, a heated hose construction 310 can include a relatively thin walled conduit around which is wound one or more resistance wires or resistance ribbons and a non-conductive braid layer is disposed over the resistance wires or resistance ribbons. A different type of support member 320 is provided in this embodiment for the heated hose construction, since the heated hose construction is generally not self-supporting. Thus, a member is required to hold, bear, carry, prop or brace the heated hose construction. In this embodiment, the support member can be in the form of a trough or the like by which a linearly extending length of heated hose construction is supported. While winding the heated hose construction around a central support structure as disclosed in embodiments discussed above is beneficial in order to maximize the amount of heat exchange area that can be packed into a given volume, it is quite possible that in certain applications beneficial results could be obtained from employing a continuous straight length of a heated hose construction. In fact, the heated hose construction could be tied to a support such as a rail if so desired. However, a ground plane or member will likely also be required.

In addition, if a self-supporting heated hose construction is desired, it may be possible to wrap the thin-walled tube or conduit, and the resistance wire or resistance ribbon wound around it, in one or more outer layers of non-conductive braid which layers together are thick enough to provide sufficient rigidity to the heated hose construction so that it could be self-supporting. This embodiment, as with the linear embodiment illustrated in FIG. 11, is feasible as long as a ground plane is provided for the heated hose construction.

The disclosure has been described with reference to several embodiments. Obviously, alterations and modifications will occur to others upon a reading and understanding of this specification. It is intended to include all such modifications and alterations insofar as they come within the scope of the appended claims or the equivalents thereof.

1. A heater assembly comprising:
a heated hose construction comprising:
a thermoplastic conduit having a wall thickness between 0.003 and 0.045 inches (0.0076 and 0.1143 cm) through which conduit a process fluid to be heated flows,
a resistance wire or resistance ribbon wound around an exterior periphery of the conduit and in thermal communication therewith, wherein an overall coverage of a surface area of the conduit by the resistance wire or resistance ribbon is at least 50% of the surface area of the conduit, so that the resistance wire or resistance ribbon reinforces or supports the conduit,
a non-conductive braid layer disposed over the resistance wire or resistance ribbon, wherein the braid layer is permeable to vapor leaking out of the conduit; and
a support member for the heated hose construction.

2. The heater assembly of claim 1 wherein the thermoplastic conduit comprises at least one of a polytetrafluoroethylene (PTFE), perfluoroalkoxy resin (PFA), and fluorinated ethylene propylene (FEP) material.

3. The heater assembly of claim 1 further comprising a ground member contacting the heated hose construction.

4. The heater assembly of claim 3 wherein the ground member comprises at least one of a metal foil contacting the braid layer and a metal portion of the support member.

5. The heater assembly of claim 1 wherein the support member in cross-section defines a circle, an oval or has an elliptical shape and the heated hose construction is wound on the support member.

6. The assembly of claim 5 wherein the support member comprises a trough.

7. The assembly of claim 1 wherein a diameter of the resistance wire or a thickness of the resistance ribbon is between 0.006 in (0.015 cm) and 0.102 in (0.25 cm).

8. The assembly of claim 1 wherein the resistance wire has a gauge between 34 and 10.

9. The heater assembly of claim 1 wherein a watt-density of the resistance wire or resistance ribbon is between 2 watts/in² (0.31 w/cm²) and 50 watts/in² (7.75 w/cm²).

10. The heater assembly of claim 1 wherein a thickness of the braid layer is between 0.010 and 0.060 inches (0.025 and 0.152 cm).

11. The heater assembly of claim 1 further comprising a housing which encloses the support member and the heated hose construction supported by it, wherein the housing includes a chamber accommodating the support member, a purge fluid inlet communicating with the chamber and a purge fluid outlet communicating with the chamber.

12. The heater assembly of claim 11 further comprising a process fluid inlet communicating with the heated hose construction and a process fluid outlet communicating with the heated hose construction.

13. The heater assembly of claim 11 further comprising an insulation layer disposed in the chamber of the housing and located between an inner wall of the housing and an outer surface of the braid layer.

14. The heater assembly of claim 1 wherein at least one helix of the resistance wire or resistance ribbon is wound around the conduit.

15. The heater assembly of claim 1 wherein a first coil of the heated hose construction wound around the support member is overlaid by a second coil of the heated hose construction.

16. A method for manufacturing a heater assembly comprising:
providing a thermoplastic conduit having a wall thickness between 0.003 and 0.045 inches (0.0076 and 0.1143 cm);
coiling a resistance wire or resistance ribbon around the conduit;
reinforcing the conduit with the resistance wire or resistance ribbon such that an overall coverage of an exterior surface area of the conduit by the resistance wire or resistance ribbon is at least 50% of the exterior surface area of the conduit;
positioning a non-conductive braid layer over the resistance wire or resistance ribbon to define a heated hose construction; and,
mounting the heated hose construction on or to a support member.

17. The method of claim 16 further comprising grounding the heated hose construction.

18. The method of claim 16 further comprising positioning the support member with the heated hose construction mounted on it within an enclosure.

19. The method of claim 18 further comprising conducting a purge fluid through the enclosure.

20. The method of claim 16 wherein the step of mounting the heated hose construction on or to the support member comprises winding the heated hose construction onto the support member in a first coil; and
further comprising winding a second coil of the heated hose construction over the first coil.
